(19) United States
(12) Patent Application Publication
(10) Pub. No.: US 2002/0103700 A1
(43) Pub. Date: Aug. 1, 2002

(54) System & method for composition of advertising medium

(76) Inventor: Laszlo Gathy, Coral Springs, FL (US)

Correspondence Address: Mr. John H. Faro, Faro & Associates, P.O. Box 4904, Key Biscayne, FL, 33149-4904, US

(21) Appl. No.: 09/770,748

(22) Filed: Jan. 26, 2001

(51) Int. Cl. G06F 17/60

(52) U.S. Cl. 705/14

(57) ABSTRACT

A system and method for system for compilation of merchant specific sales and promotional information, relating to products and services available from such merchants, with a given geographic market or locality. The compilation is offered to consumers on a machine readable medium to permit consumer sorting and retrieval of product and service specific information available with the locality, from merchants located within the geographic market or locality of the target consumer. The medium is useable independent of an internet server of web browser, and, is, thus, intended to promote local enterprise and consumer traffic within merchants' places of business. The compilation of product and service information on the medium includes an internal clock and expiration date to insure that the consumer is not mislead as to the date of expiration of a promotion or sale.

### BACKGROUND OF THE INVENTION

1. Field of the Invention

This invention relates to a system and to a method. More specifically, this invention relates to system and method for the preparation of an assemble of advertising materials from unrelated sources of products and services on a common advertising medium.

2. Description of the Prior Art

Notwithstanding the internet revolution, the “mom and pop” retailer and, even the local merchants of substance, are still required to advertise in the press and fliers distributed within their local markets, to both spark consumer interest, and alert the local markets that each serves, of specials and sales promotions that each offered periodically. Thus, they each have and continue to solicit business in the traditional press and media (e.g. radio and television). Moreover, the consumer continues to be bombarded by such local merchants with voluminous amounts of junk mail, which for the most part, is discarded, often with any thoughtful review and/or consideration.

Accordingly, there continues to exist a need to present these local merchants with a more effective way to get their promotional and advertising messages across to the local markets that each serves in a manner that accommodates their respective and diverse needs, while at the same, presenting their potential customers with an advertising format that is easier to review, and preferably compatible with the computer based resources that consumers have come to expect from retailers.

Past efforts as adaptation of computer based systems to marketing and promotional efforts of merchandiser are disclosed in the patent literature. The following are representative of such past efforts. Each of these patents are discussed in chronological order, based upon their date of issue, and thus no significance is to be attached to the order of discussion.

U.S. Pat. No. 5,710,886 (to Chritensen et al, issued Jan. 20, 1998) discloses a method and apparatus for distributing, generating, and redeeming discount coupons, rebate or gift certificates or the like. In the Chritensen et al method, coupons may be distributed electronically, for example, in the form of a diskette or CD-ROM software. Software on the diskette or CD-ROM may prompt a consumer to call a 1-800 number for a validation number or code. During the phone call, telemarketing personnel may request consumer demographic and or identification information which may be entered into a centralized database. Once the software is validated, a consumer may print out selected coupons displayed on a Graphical User Interface (GUI). Each coupon may be printed only a limited number of times. Each coupon may be imprinted with a consumer ID number, preferably in the form of a bar code. Once redeemed, consumer ID information and coupon information may be retrieved from coupons forwarded to a coupon clearing house. Accurate data may then be produced illustrating which consumers or groups of consumers are redeeming which coupons. Such data may be used for marketing purposes or to generated further diskettes for distribution targeting specific consumers or groups of consumers with specific classes of coupon offerings. The use of a consumer ID number on the coupon reduces and/or prevents the fraudulent copying and redemption of coupons, as multiple redemptions of a single coupon by a consumer may be readily detected from data gathered at the brokerage clearing house.

U.S. Pat. No. 5,915,243 (to Smolen, issued Jun. 22, 199) discloses a method and apparatus for offering promotions to a consumer on the basis of a dynamic information profile for that consumer. The dynamic information profile is formed by creating an initial information profile for the consumer, selecting questions for the consumer based on the information profile, presenting the questions to the consumer, collecting the responses to the questions, and updating the information profile using the responses to the questions. Promotions can be offered to a consumer based upon the entire information profile or a portion of the information profile.

U.S. Pat. No. 6,032,130 (to Alloul et al, issued Feb. 29, 2000) discloses an electronic system (e.g. electronic catalog) that provides multimedia product presentations in real-time, by combining locally-stored data and data received from a remote server. Large volumes of data, representing product information such as motion images and sound, are stored locally on the system's data storing unit for fast data access. Small volumes of product time-variable data are received over a network from a remote server, which also has a transaction management function. The purchasing system combines the local and received data in order to provide both real-time and up-to-date product information to customers. Two versions of the purchasing system are provided. The first one is a multimedia public purchasing kiosk for use in malls and shopping centers. The second one is a PC-based purchasing system, equipped with multimedia capabilities. It uses a purchasing application which is distributed beside the large volumes of product-related data on a portable support such as a CD-ROM and which is intended for personal use, at home, on the customer's PC.

The Alloul et al, method is geared to the electronic presentation of real-time, up to date catalog of information to consumers, including current price and availability information, and ordering capability—a retailers web page in a box (on CD). The advantages and distinctive character of the Alloul et al, method resides in its combining of transmitted and locally stored data in a common media (CD), wherein small volumes of time-variable data (price and product availability) are used to update the merchants catalog. The dynamic features of the CD include on-line purchasing/transaction features (order forms, credit card debiting of accounts, etc.). In one of the preferred embodiments of this invention a kiosk is provided to dispense CDs catalogs to consumers.

As is evident from the foregoing, the prior art systems are geared to catalog sales of larger merchants and/or alternatively, to limited specific/objectives (prevention of coupon fraud) of such larger merchants. Accordingly, there continues to exist a need to provide local merchants a cost effective means for attracting local customers within their immediate geographic markets, without the inefficiencies inherent in mass mailings and the traditional promotional methods.

### OBJECTS OF THE INVENTION

It is the object of this invention to remedy the above as well as related deficiencies in the prior art.

More specifically, it is the principle object of this invention to provide a system and method for providing unrelated merchants, within a given locality, a cost effective method for promotion of their business and sales events to consumers within their immediate geographic markets.

It is another object of this invention to provide a system and method for providing unrelated merchants, within a given locality, for promotion of their business and sales events on a common medium.

It is yet another object of this invention to provide a system and method for providing unrelated merchants, within a given locality, for promotion of their business and sales events on a common medium that is geared to present day consumer preference for computer based shopping systems.

It is still yet another object of this invention to provide a system and method for providing unrelated merchants, within a given locality, for promotion of their business and sales events on a common medium, including means for accessing their local merchant's web pages, and related links, for products available locally from local outlets.

### SUMMARY OF THE INVENTION

The above and related objects are achieved by providing a system for the dynamic assembly and creation of a common advertising medium, which includes goods and services available from local merchants (hereinafter also “merchant specific information”), including competing merchants, within a given locality. In one of the preferred embodiments of this invention, each of the merchants has an account with the system provider, which permits the individual merchant's downloading of their business promotional and sales information to a system server. The server thereupon compiles the individual merchant specific information within a standardized format, so as to initially arrange and thereafter permit retrieval of such merchant specific information, based upon consumer preference, in for example, assigned product categories, area code (proximity to consumer), alphabetical order, price ranges, ethnic preferences (restaurant menu), etc. The compilation occurs at a time certain (closing date), and thereafter such compilation is formatted and a recorded on a machine readable medium (Floppy Disk, CD, ZIP Drive Disk, etc.). The medium is then distributed by the system to a local consumer base within the immediate geographical locale (preferable within 50 miles and less than 100 miles) of the merchandising locality of the participating merchants). The participating merchants would be free to include their web page address, or a telephone number or a dynamic link to a web browser, so as to afford the consumer the ability to confirm price and product availability before physically visiting the merchants place of business. The merchant could also provide a “lay away” feature to insure product reservation for the consumer.

The medium would be periodically (monthly or bimonthly) up-dated on each so as to provide additional products and promotion of participating merchants, or to add new participating merchants, or to delete merchants who were no longer subscribing to the system. In order to insure the continued active participation of the merchants, the medium would include a clock that would be set to expire on a “closing date” for insertion of new merchant specific information into the next edition of the medium, thus, insuring currency of the information of the medium, and continued merchant patronage of the system.

### PBRIEF DESCRIPTION OF THE DRAWINGS

FIG. 1 is an illustration of a server of the system of this invention, wherein individual merchant subscribers access the server over a modem or internet connection and download promotional and sales information specific for their account onto the server. FIG. 1 also shows the use of the output (compilation) in the form of a CD on a personal computer for searching the products and services in the merchant specific files created on the CD.

### DESCRIPTION OF THE INVENTION INCLUDING PREFERRED EMBODIMENTS

The system and method of this invention provides a merchant accessible portal for supply, or download, of merchant specific promotional and sales information, for compilation and distribution, along with other information from unrelated business, to potential consumers, within a given geographic locality. The merchant account with the system includes a merchant profile and preferences for the placement of the merchant specific information, in one or more system categories, within the system compilation of the information from the system merchant subscribers. Thus, the merchant can predesignated the categories within the compilation where its desires its merchant specific information to be referenced and/or appear. The compilation of merchant specific information can be in the form of a machine readable medium, wherein the consumer can search the medium, based upon category and/or preference, and thereby readily identify the merchant within his locality that has a product or service that fits his/her needs. In one of the preferred embodiments of this invention, the merchant can also, at its option, included its web page address, or other location related information (map) to assist the consumer in the patronage of its local outlet. The compilation of promotional and sales information, and the medium containing the merchant specific information is not to be confused with a web browser or web page that is accessible on the PC, nor does it include order processing information. The compilation of this invention is simply intended to provide an enhanced, computer searchable library of promotional and sales information for a number of merchants within a given geographic locality (that is up-dated periodically), in a user friendly format. Because of the computer orientation of medium format, the user is permitted to review the merchant specific information much in the same manner as it would on a web browser/page. Unlike a web browser/page, the medium is not internet access dependant, thus, suitable for individuals that do not have or desire the assistance of a internet server provider or web browser, with its numerous unsolicited advertisements and frequent interruption in service.

Because of the medium's categorization of the products and services in an ordered array, the user can search for the desired service from among the merchants within his/her immediate locale. Because the medium is not internet server dependant, the use thereof avoids the security problems associated with the disclosure of credit card information on-line, and the return of merchandise ordered on-line. The user friendly, computer searching functions that are configured and/or associated with the medium of this invention, thus, preserves the best of computer based searching for products and services of interest, without any of the hassles associated with on-line merchandising/ordering systems.

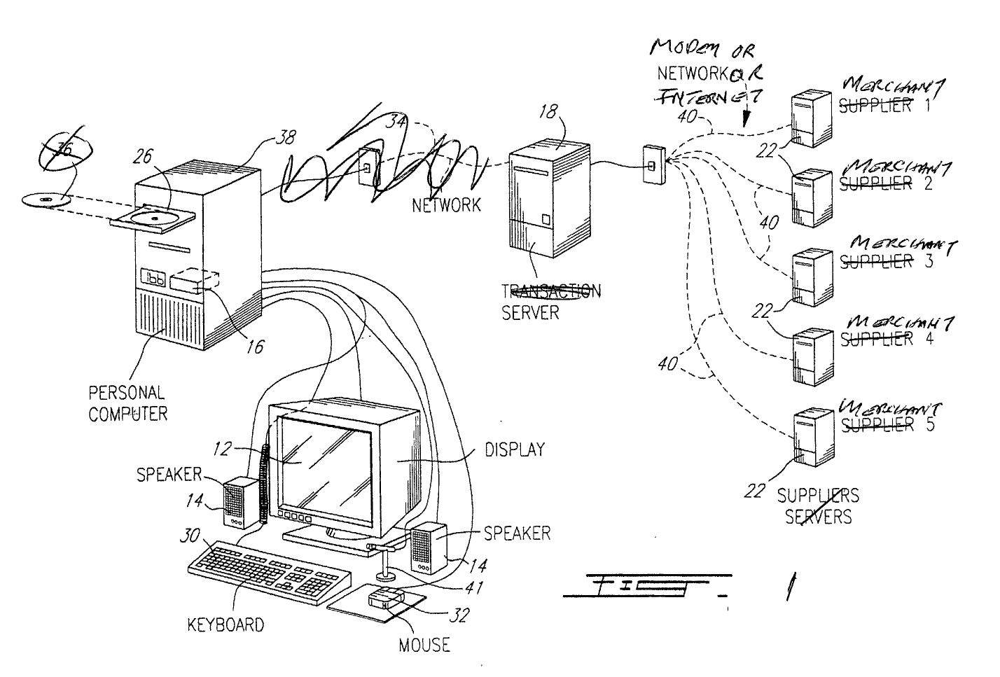

FIG. 1 depicts a flow chart wherein system subscribers (merchants) can access and download merchant specific information to a system server, for a given system account, for later compilation into the medium of this invention. In brief, the overall system of this invention contemplates the centralized collection of promotional and sales information from unrelated merchants by a system that has a standardized format for organization and retrieval thereof by user friendly, computer searching techniques. Thus, the merchant can select from among the key words list of the system which best describe its product and service, and thereby provide for consumer retrieval of its advertisement from the medium by the consumer.

It is assumed in the illustration provided in FIG. 1, that each of the merchant subscribers have completed a merchant profile in which each has designated certain categories, within the system, that are specific for its targeted consumer or one or more categories of consumer interest. Each of the merchants is also provided with an account identifier permitting it access to the system to compose, alter and/or up-date the promotional and sales information to be included in the compilation for its account. It is important to emphasize that the system and the compilation are open to all, and, thus, competing merchants can and are encouraged to advertise on the same medium to permit consumer comparison of available services and merchandise.

Once the merchant specific information is resident on the system server, it is compiled in the format of the medium suitable for sorting and retrieval by standard data base processing techniques. The resultant media, e.g., CD, can then be placed in a PC (personal computer) or comparable device, and the CD accessed in the conventional manner. The medium includes a software interface, (which has a data base manipulation capability(, for interrogating the merchant specific information in the medium, based upon the field organization of such files, and thereupon retrieval of merchant specific information, within the fields of interest to the consumer.

For example, if the consumer (user) desired to shop for hiking boots, or alternatively, search the medium for merchants offering outdoor or sporting goods, the merchants specific files could be accessed in such fashion, so as to afford the user information as to local merchants that have products that are not only specific for his particular needs (boots), but also related to his interest (hiking or camping).

Once the product or merchants has been identified, the consumer could view images of the products or animation of the product in use or different views of the product, depending upon the content of the merchant specific files. The medium can also include a merchant web page address, or graphics (maps to direct the consumer to the merchant location, etc.). The content of the merchant specific files would only be limited by the merchants imagination, and amount of memory supportable on the medium that was allocated to a given merchant account.

What is claimed is:

1. In a system for composition of an area specific, machine readable, advertising medium, wherein the product and/or service specific information included therein is retrievable by user friendly, computer-based sorting and searching techniques, based upon anyone of a number of user specified search parameters and preferences of a target consumer for the advertising medium,
wherein the improvement comprises:
A. a server having an array of fields corresponding to one or more parameters useful in the characterization of goods and/or services that are available from a given population of merchant subscribers to a system;
B. means for permitting access of said merchant subscribers to said server, wherein said access means includes means for downloading to said server, merchant specific information relative to products and services offered by said merchants subscribers, and a locality or business address, within a given geographic territory convenient to a consumer population base, where such products and services are available; and
C. means for compilation of said merchant subscriber information, relative to the products and services offered by said merchants subscribers, onto a machine readable medium, said medium having searching means for sorting and retrieval of said merchant subscriber information relative to products and/or services, based upon one or more user specified criteria and/or preferences.

2. The system of claim 1, wherein said medium includes geographical map information and/or directions to a merchant subscriber having a product or service of interest to a user of said medium.

3. The system of claim 2, wherein said medium includes a clock for rendering said medium inaccessible from and after an expiration date for said medium

4. The system of claim 1, wherein said medium includes a data base compilation of merchant specific product and service related information that is retrievable, based upon a single field, or combination of fields, depending upon user specified search criteria and/or preferences.
